(19) United States
(12) Patent Application Publication
(10) Pub. No.: US 2016/0130081 A1
(43) Pub. Date: May 12, 2016

(54) METHOD AND APPARATUS FOR LINING A TRASH RECEPTACLE

(71) Applicant: Kenneth HARRIS, N. Hollywood, CA (US)

(72) Inventor: Kenneth HARRIS, N. Hollywood, CA (US)

(21) Appl. No.: 15/001,166

(22) Filed: Jan. 19, 2016

(51) Int. Cl. B65F 1/06

(52) U.S. Cl. CPC B65F 1/062

(57) ABSTRACT

Method and apparatus for lining a trash receptacle. The present method and embodying apparatus provide for receiving a roll of trash liners, dispensing the linear feed from a caddy and receiving the linear feed in the trash receptacle by means of an orifice situated near the bottom of the trash receptacle. When the trash liner needs to be replaced, it is pulled clear of the trash receptacle and a subsequent liner is drawn into the trash receptacle.

### BACKGROUND

One household chore that is sometimes so difficult to cope with is that of changing a trash liner in a trash receptacle. Although it may not sound like that big of a problem, the few extra steps necessary to obtain a new trash liner can push someone over the edge, especially after a long day at the office. And, there are those days where the trash liners somehow relocated themselves from under the kitchen sink to the laundry room. The mole hill grows quickly into a mountain.

This issue has not gone unnoticed before. For example, there are convenience trash receptacles that include a hidden compartment under the main cavity of the trash receptacle. In this type of convenience receptacle, the hidden compartment is used to store trash liners, which are pulled up into the main cavity through a hole in the bottom of the main cavity of the trash receptacle. At first, this seems like an extremely elegant means of solving the problem and immediately dispenses with the question “where are the liners today?”

This solution, though, has several drawbacks. First, the hidden compartment either adds to the overall height of the trash receptacle. If not, the overall capacity of the trash receptacle must be compromised to accommodate a store of trash liners. The fact that the hole is placed in the bottom of the main cavity of the trash receptacle also causes issues should a trash liner tear and liquid is lost from the trash liner. Any liquid finding its way into the bottom of the trash receptacle can then pass through the hole and contaminate all of the trash liners stored in the hidden compariment. Worse still, the liquid could escape the trash receptacle all together and contaminate the environment.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram that depicts one example method for lining a trash receptacle;

FIG. 2 is a flow diagram that depicts one alternative method for providing a caddy for a plurality of trash liners;

FIG. 3 is a flow diagram that depicts one alternative method for providing an orifice through a vertical perimeter;

FIG. 4 is a flow diagram that depicts an alternative method that is useful when liquid is inadvertently introduced into a bottom portion of the volume provided by a trash receptacle;

FIG. 5 is a flow diagram that depicts one alternative method for replacing a trash liner;

FIG. 6 is a pictorial diagram that depicts one example system for lining a trash receptacle;

FIG. 7 is a cross section view of one example embodiment of a caddy;

FIG. 8 is a pictorial diagram that illustrates the path for feeding trash liners into a trash receptacle; and

FIG. 9 is a pictorial diagram that depicts a travel path of a linear feed of trash liners dispensed by a caddy and received in a trash receptacle.

### DETAILED DESCRIPTION

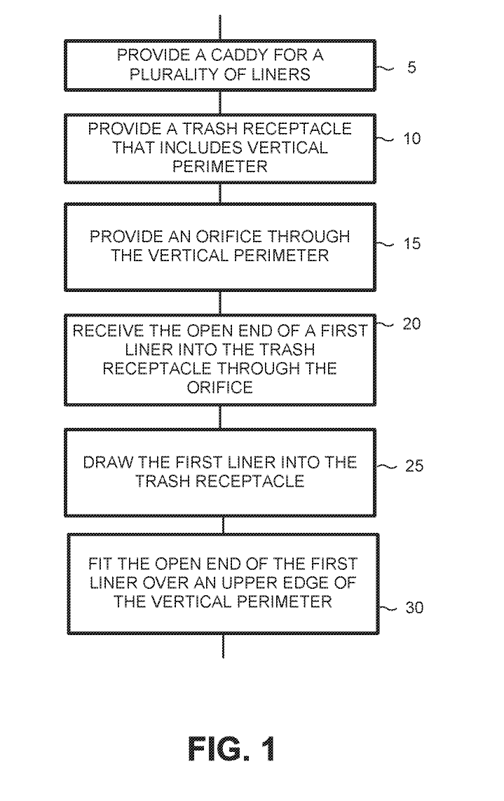

FIG. 1 is a flow diagram that depicts one example method for lining a trash receptacle. First, a caddy to contain a plurality of trash liners is provided (step 5). It should be appreciated that, according to this example method, the plurality of trash liners comprises a linear group where a first liner is provided and said first liner is temporally attached to a subsequent liner. In one alternative method, the first liner is provided with an open end and the closed end of the liner is temporally attached to the open end of a subsequent, or second liner. In one alternative illustrative use case, the plurality of trash liners are attached to each other, tail to head, by means of a perforated tear line.

A second step, step 10, of this example method includes providing a trash receptacle. In most applications of this example method, the trash receptacle includes a bottom surface and a perimeter of vertical walls surrounding the bottom surface. An orifice is then provided (step 15) from outside of the receptacle to the inside of the receptacle wherein the orifice penetrates the vertical perimeter.

Using the provided for orifice, a first trash liner is drawn through into the volume defined by the bottom surface and the vertical perimeter. This is accomplished by first receiving an open end of a first trash liner into the orifice (step 20) and then drawing the first trash liner into the internal volume of the trash receptacle (step 25). Once a first trash liner has been drawn into the internal volume of the trash receptacle, the open end of this first trash liner is fitted over an upper edge of the vertical perimeter (step 30).

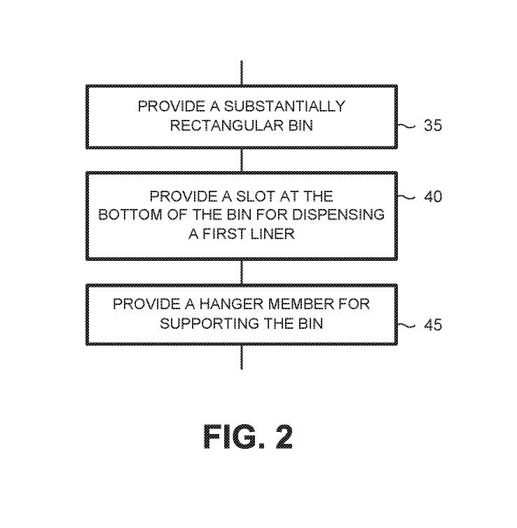

FIG. 2 is a flow diagram that depicts one alternative method for providing a caddy for a plurality of trash liners. It should be appreciated that, according to this example method, a caddy is provided by providing a substantially rectangular bin (step 35). In practice of the present method, a plurality of trash liners is placed in the rectangular bin. In order to feed trash liners into the trash receptacle, this example method includes providing a slot at the bottom of the caddy bin (step 40). The caddy itself is then supported from the upper edge of the using a hanger member, which is also provided by this example alternative method (step 45).

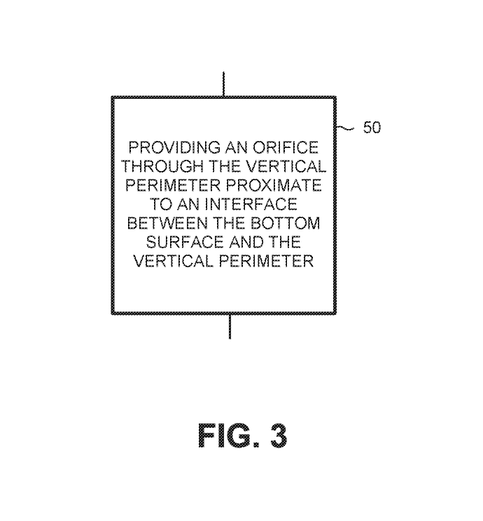

FIG. 3 is a flow diagram that depicts one alternative method for providing an orifice through a vertical perimeter. In this alternative method, an orifice is disposed in the vertical perimeter proximate to an interface between the vertical perimeter and the bottom surface of the trash receptacle (step 50).

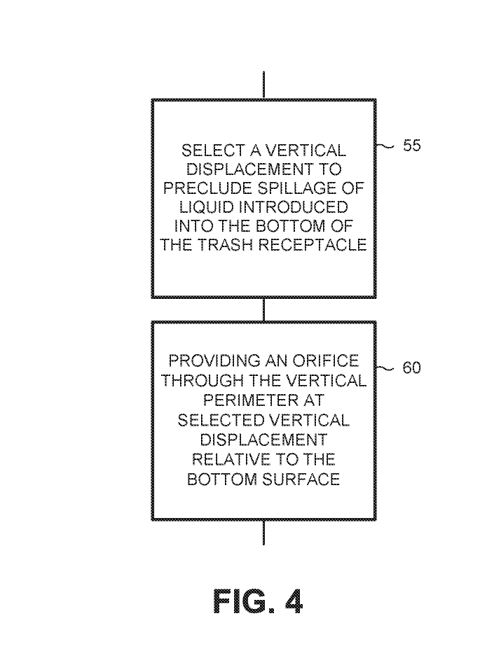

FIG. 4 is a flow diagram that depicts an alternative method that is useful when liquid is inadvertently introduced into a bottom portion of the volume provided by a trash receptacle. In this alternative method, an orifice in the vertical perimeter is provided by selecting a vertical displacement (step 55) and then positioning the orifice at the selected vertical displacement (step 60). It should further be appreciated that the vertical displacement is selected to minimize spillage of a liquid through the orifice, inadvertently introduced into the lower portion of a trash receptacle.

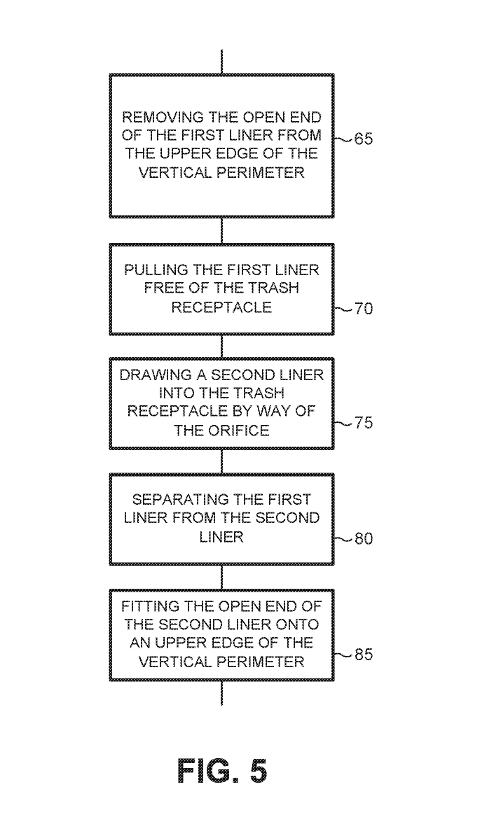

FIG. 5 is a flow diagram that depicts one alternative method for replacing a trash liner. In one illustrative use case, a trash liner will be replaced when it is filled to capacity. In this alternative example method, an open end of a trash liner is removed from the upper edge of the vertical perimeter (step 65). At this point, the trash liner that is to be removed may optionally be sealed or tied off. After removing the trash liner from the upper edge of the vertical perimeter, it is pulled clear of the trash receptacle (step 70). Because the closed end of the first trash liner is temporally attached to the open end of the next trash liner, pulling the first trash liner clear of the trash receptacle pulls the next trash liner through the orifice (step 75) and into position to replace the previous, now filled trash liner.

Once the second trash liner is pulled into position, the first liner is separated from the second liner (step 80). The open end of the second liner is then fitted over the upper edge of the vertical perimeter (step 85).

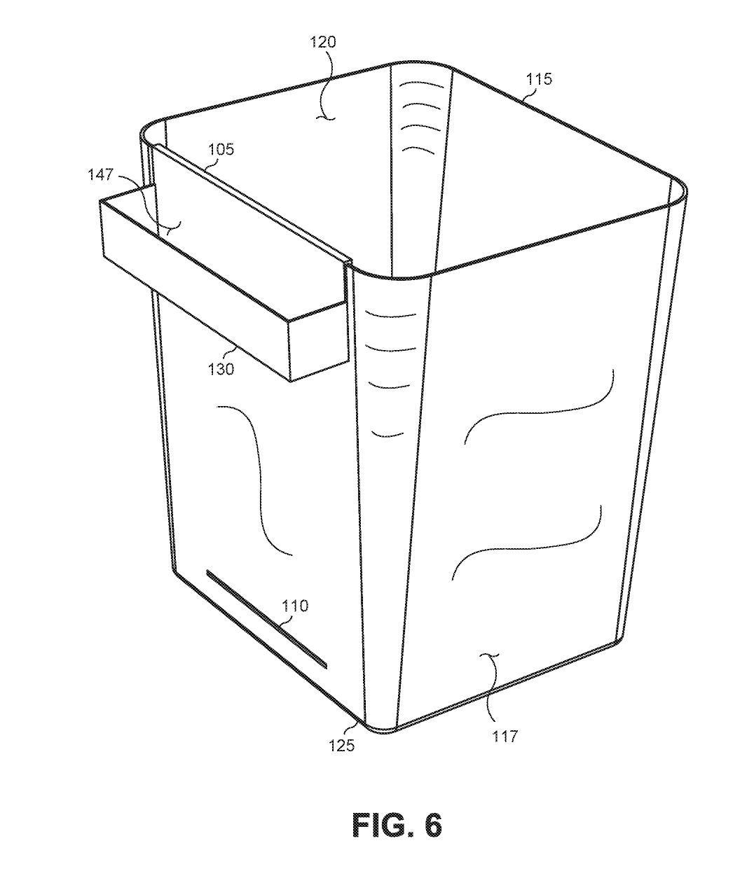

FIG. 6 is a pictorial diagram that depicts one example system for lining a trash receptacle. In this example embodiment, a system that implements the teachings of the present example methods comprises a caddy 130 and a trash receptacle 125. The caddy 130 defines a volume 147 for receiving a plurality of trash liners. A slot 135 at the bottom of the bin 147 allows a first trash liner to pass downward and to be fed into the trash receptacle 125 by way of an orifice 110.

As can be appreciated, the trash receptacle defines a volume 120 that is surrounded by a vertical perimeter 117, included in this embodiment. This vertical perimeter includes an upper edge 115. The vertical perimeter 117 rises upward from a bottom surface 119 that is also included in the trash receptacle 125. In this example embodiment, the caddy 105 is supported from the upper edge 115 of the trash receptacle 125. The trash receptacle of this alternative embodiment also includes an orifice 110 that penetrates the vertical perimeter 117 and enables a trash liner to be fed into a bottom portion of the trash receptacle volume 120.

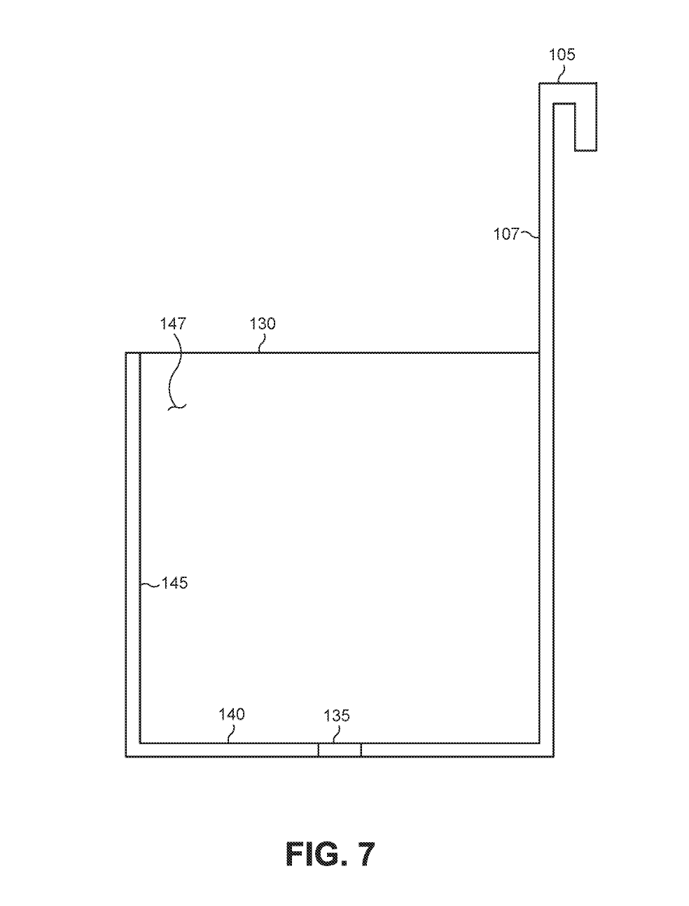

FIG. 7 is a cross section view of one example embodiment of a caddy. In this example embodiment, a caddy 130 comprises a vertical perimeter 145 and a base plate 140. The vertical perimeter 145 surrounds the baseplate 140 and defines a volume 147 that is a substantially rectangular bin. The caddy 130 further comprises an orifice 135 disposed in the base plate 140. In one alternative embodiment, the caddy 130 also includes a hanging member 107. In yet another alternative embodiment, the hanging member 107 includes a hook 105 that is used to support the caddy 130 from the upper edge 115 of the vertical perimeter 117 included in the trash receptacle 125.

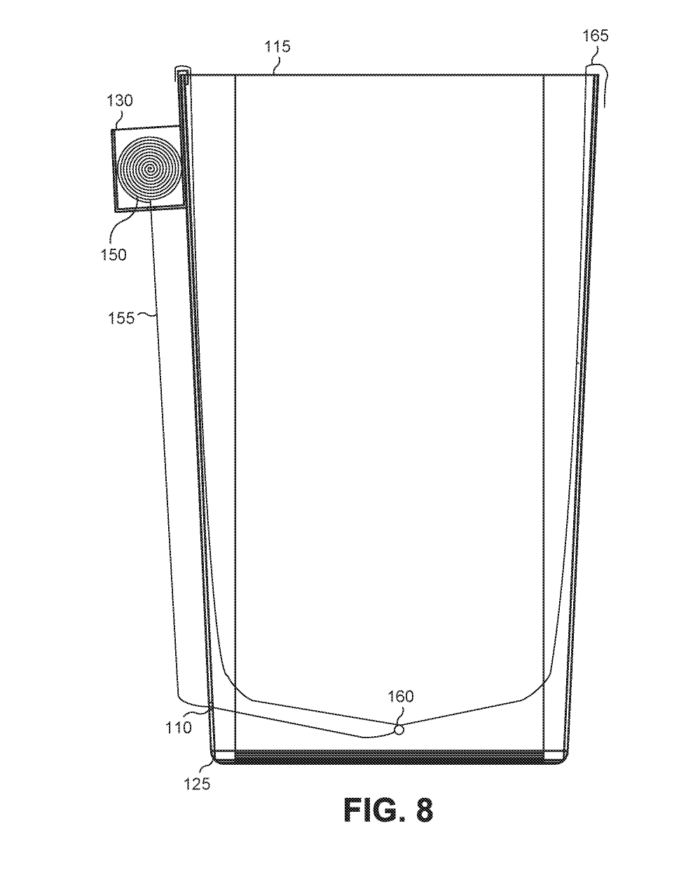

FIG. 8 is a pictorial diagram that illustrates the path for feeding trash liners into a trash receptacle. In this example embodiment, the caddy 130 receives a roll 150 of trash liners. The roll 150 dispenses a first trash liner 165, which is fed into the volume 120 defined by the trash receptacle by way of the orifice 110 that is included in the vertical perimeter 117 of the trash receptacle 125. It should be appreciated that an open end of the first trash liner 165 is folded over the upper edge 115 of the vertical perimeter 117. A closed end of the first liner 165 is attached to a second trash liner 155 using a tear line 160.

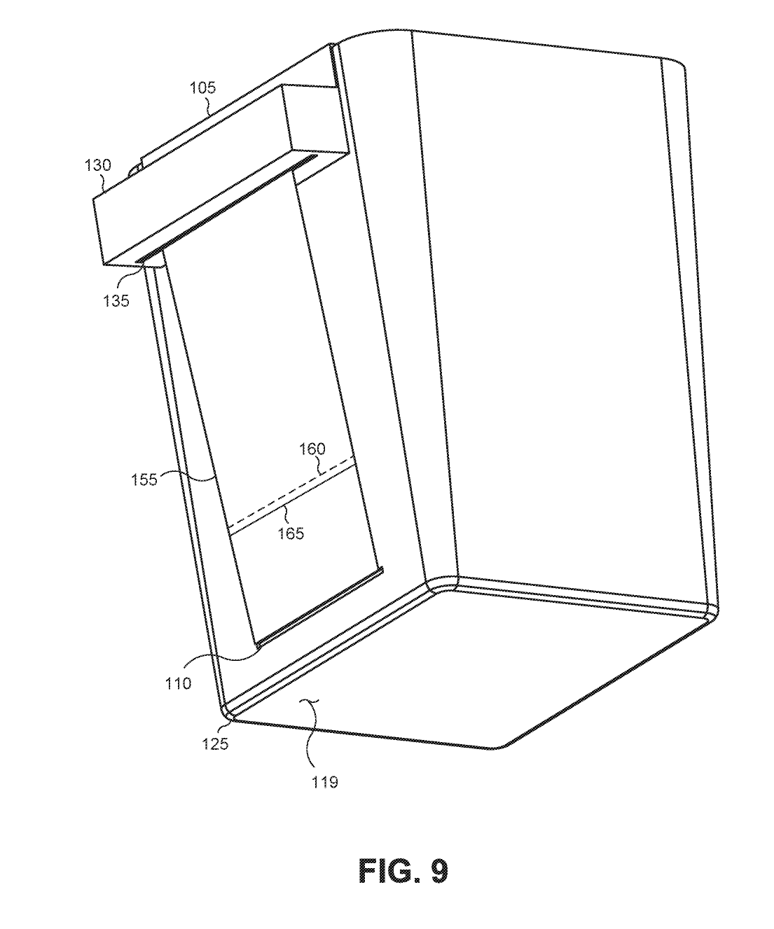

FIG. 9 is a pictorial diagram that depicts a travel path of a linear feed of trash liners dispensed by a caddy and received in a trash receptacle. As already described, the caddy 130 is supported, at least in this example embodiment, by a hook 105 included in the caddy 130. The hook 105 is placed over an upper edge 115 of the trash receptacle 125. A roll of trash liners 150 is contained in the caddy 130 and, as the roll dispenses trash liners, a linear feed 155 travels through a slot 135 situated in the bottom of the caddy 130.

A linear feed 155 of trash liners is also included in a system for lining a trash receptacle. It should be appreciated that said linear feed 155 includes a succession of trash liners that are dispensed open end first. At each additional trash liner, a solid seem 165 defines a closed end of a liner followed by a tear line 160. In one alternative embodiment, the tear fine comprises a perforation, which can be used to tear a first trash liner from a subsequent trash liner.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

What is claimed is:

1. A method for lining a trash receptacle comprising:
providing a caddy for a plurality of liners wherein the plurality of liners comprises a first liner attached to a second liner by a tear line and wherein the first liner comprises an open end;
providing a trash receptacle comprising a bottom internal surface and a vertical perimeter;
providing an orifice through the vertical perimeter;
receiving the open end of the first liner into the trash receptacle by way of the orifice;
drawing the first liner into the trash receptacle; and
fitting the open end of the first liner over an upper edge of the vertical perimeter.

2. The method of claim 1 wherein providing a caddy for a plurality of liners comprises:
providing a substantially rectangular bin;
providing a slot at the bottom of the bin for dispensing a first liner; and
providing a hanger member for supporting the bin from an upper edge of a vertical perimeter included in a trash receptacle.

3. The method of claim 1 wherein providing an orifice through the vertical perimeter comprises:
providing an orifice through the vertical perimeter proximate to an interface between the bottom surface and the vertical perimeter.

4. The method of claim 1 wherein providing an orifice through the vertical perimeter comprises:
providing an orifice through the vertical perimeter at a vertical displacement relative to the bottom surface, wherein the vertical displacement is selected to preclude spillage of liquid introduced into the bottom of the trash receptacle.

5. The method of claim 1 further comprising:
removing the open end of the first liner from the upper edge of the vertical perimeter when the first liner is to be replaced;
pulling the first liner free of the trash receptacle while drawing the second liner into the trash receptacle by way of the orifice;
separating the first liner from the second liner along the tear line; and
fitting the open end of the second liner onto an upper edge of the vertical perimeter.

6. A system for lining a trash receptacle comprising:
caddy for storing trash liners comprising:
base plate and vertical perimeter surrounding the base plate defining a substantially rectangular cavity said vertical perimeter including two short segments and two long segments;
substantially rectangular orifice disposed in the base plate, said orifice being sized in width to accommodate a linear feed of trash liners;
support member being disposed proximate to an upper edge of one of the two long segments; and
trash receptacle comprising:
vertical perimeter surrounding a bottom surface defining a volume that substantially rectangular; and
orifice penetrating the vertical perimeter proximate to an interface between the bottom surface and the vertical perimeter.

7. The system for lining a trash receptacle of claim 6 wherein the support member comprises:
hook shape that is structured to fit over a top edge of the vertical perimeter included in the trash receptacle.

8. The system for lining a trash receptacle of claim 6 wherein the orifice penetrating the vertical perimeter included in the trash receptacle is offset from the bottom surface of the trash receptacle by a distance selected to minimize spillage through the orifice.

9. The system for claim 6 further comprising:
plurality of liners including an open end and a closed end, wherein the closed end of a preceding liner is temporally attached to an open end of a succeeding trash liner.

10. An apparatus for lining a trash receptacle comprising:
means for containing a plurality of liners wherein the plurality of liners comprises a first liner attached to a second liner by a tear line and wherein the first liner comprises an open end;
means for containing trash comprising a bottom internal surface and a vertical perimeter; and
means for receiving the open end of the first liner into means for containing trash.

11. The apparatus of claim 10 wherein the means for containing a plurality of liners comprises:
means for hanging the means for containing a plurality of liners from an upper edge of a vertical perimeter included in the means for containing trash.

12. The apparatus of claim 10 wherein providing an orifice through the vertical perimeter comprises:
providing an orifice through the vertical perimeter proximate to an interface between the bottom surface and the vertical perimeter.

13. The apparatus of claim 10 wherein means for receiving the open end of the first liner into means for containing trash comprises:
means for receiving the open end of the first liner into a lower portion of the means for containing trash.
